(19) United States
(12) Patent Application Publication
(10) Pub. No.: US 2018/0050589 A1
(43) Pub. Date: Feb. 22, 2018

(54) TRANSMISSION AND AN ELECTRIC VEHICLE PROVIDED WITH THE TRANSMISSION

(71) Applicant: Zhejiang Easy Vehicle Co., Ltd., Yongkang (CN)

(72) Inventors: Sam Yu, Yongkang (CN); Yong Wen, Yongkang (CN)

(21) Appl. No.: 15/678,931

(22) Filed: Aug. 16, 2017

(30) Foreign Application Priority Data
Aug. 16, 2016 (CN) 201620889516.0

(51) Int. Cl. B60K 17/04; B60K 17/14; B60K 7/00

(52) U.S. Cl. CPC B60K 17/043; B60K 17/14; B60Y 2200/91; B60K 2007/0061; B60K 7/0007

(57) ABSTRACT

A transmission comprises an input end connected to a driving device, an output end connected to a rear wheel, a gear transmission mechanism and a pulley transmission mechanism. The gear transmission mechanism comprises a primary gear connected to the driving mechanism. The pulley transmission mechanism comprises a driving wheel, a driven wheel and a synchronous belt. A unidirectional transmission mechanism is connected to the driven wheel with the unidirectional transmission mechanism driving the rear wheel. The transmission provides power output by the driving device, transmits power to the pulley transmission mechanism by the gear transmission mechanism, and the pulley transmission mechanism drives the rear wheel to rotate the unidirectional transmission mechanism, such that the vehicle moves forward. When power output is stopped, due to inertia of the vehicle and rotation resistance of the unidirectional transmission mechanism, the vehicle can smoothly coast, thereby saving power consumption and improving endurance mileage.

### TECHNICAL FIELD

The present invention relates to the technical field of mechanical apparatus, particularly to a transmission and an electric vehicle provided with the transmission, specifically to a transmission with small size, light weight, being capable of efficiently improving endurance mileage, and low energy consumption, and to an electric vehicle provided with the transmission.

### BACKGROUND

At present, most of transmissions applied to automobiles are relatively complex and cumbersome. When applied to an electric vehicle, particularly for an electric scooter, the transmission is required to be small, simple, practical, and to be with high safety factor and long endurance mileage. However, when a vehicle is coasting, since the existing drive train is not provided with a unidirectional transmission, both of the drive train and power unit will rotate during the coasting, thereby resulting in large coasting resistance and short coasting distance. The existing drive train is poor in practicality, unable to satisfy the requirements for a transmission by various transportation tools in the market.

### SUMMARY

### I. The Technical Problem to be Solved

The objectives of the present invention are to provide a transmission with small size, light weight, being capable of efficiently improving endurance mileage, and low energy consumption, and to provide an electric vehicle provided with the transmission, so as to solve the problem of large coasting resistance and short coasting distance due to the conventional drive train being not provided with a unidirectional transmission mechanism when a vehicle is coasting.

### II. Technical Solution

In order to solve the technical problem above, the present invention provides a transmission with an input end connected with a driving device, an output end connected with a rear wheel, the transmission comprising a gear transmission mechanism and a pulley transmission mechanism, the gear transmission mechanism comprising a primary gear connected to the driving mechanism; the pulley transmission mechanism comprising a driving wheel, a driven wheel and a synchronous belt; the driving wheel being connected with the primary gear through a gear shaft, a unidirectional transmission mechanism connected to the driven wheel being provided in the rear wheel, the unidirectional transmission mechanism being used for driving the rear wheel to rotate.

Wherein, the unidirectional transmission mechanism is connected with the driven wheel through a thread bushing.

Wherein, the rear wheel is provided with a first gear, and the periphery of the unidirectional transmission mechanism is provided with a second gear engaged with the first gear.

Wherein, the unidirectional transmission mechanism is a unidirectional flywheel or unidirectional bearing.

Wherein, the rear wheel is further provided with a wheel cover plate at the side away from the driven wheel, and the wheel cover plate is fixed to the rear wheel through screws.

Wherein, the transmission further comprises a box body provided with an opening, one side of the opening being provided with a box body cover, the other side of the opening being provided with a cover plate, the box body cover, cover plate and box body constituting a closed housing, both of the gear transmission mechanism and the pulley transmission mechanism being provided in the housing.

Wherein, a sealing plate is provided at the connection of the box body cover and the box body, and the sealing plate is disposed over the gear shaft.

Wherein, the driving device is a motor, an output shaft of the motor is connected with the primary gear, the output shaft is used for driving the primary gear to rotate.

The present invention also provides an electric vehicle comprising the transmission above.

### III. Advantageous Effects

The technical solutions above of the present invention have the following advantages: the present invention provides a transmission with an input end connected with a driving device, an output end connected with a rear wheel, the transmission comprising a gear transmission mechanism and a pulley transmission mechanism, the gear transmission mechanism comprising a primary gear connected to the driving mechanism; the pulley transmission mechanism comprising a driving wheel, a driven wheel and a synchronous belt; the driving wheel being connected with the primary gear through a gear shaft, the rear wheel provided with a unidirectional transmission mechanism connected to the driven wheel, the unidirectional transmission mechanism being used for driving the rear wheel to rotate. The transmission provided by the present application is with simple structure, occupies small space, and is light in weight; it provides power output by the driving device, transmits power to the pulley transmission mechanism by the gear transmission mechanism, and the pulley transmission mechanism drives the rear wheel to rotate through the unidirectional transmission mechanism, such that the vehicle moves forward; when the power output is stopped, due to the inertia effect of the vehicle and the small rotation resistance of the unidirectional transmission mechanism, the vehicle can smoothly coast, while the driving mechanism, gear transmission mechanism and pulley transmission mechanism are not rotating, thereby achieving the advantageous effects of saving power consumption and improving endurance mileage. The transmission is of strong practicability, beneficial to the standardized production and promotion.

### BRIEF DESCRIPTION OF THE DRAWINGS

FIG. 1 is an assembly structural diagram of a transmission of a transmission embodiment of the present invention;

FIG. 2 is an isometric view at left front 45° of a transmission of a transmission embodiment of the present invention;

FIG. 3 is a front view of a transmission of a transmission embodiment of the present invention;

FIG. 4 is a rear view of a transmission of a transmission embodiment of the present invention;

FIG. 5 is a bottom view of a transmission of a transmission embodiment of the present invention;

FIG. 6 is a top view of a transmission of a transmission embodiment of the present invention;

FIG. 7 is a left view of a transmission of a transmission embodiment of the present invention;

FIG. 8 is a right view of a transmission of a transmission embodiment of the present invention.

In the figures: 1: box body; 2: synchronous belt; 3: driven wheel; 4: thread bushing; 5: cover plate; 6: rear wheel; 7: unidirectional transmission mechanism; 8: wheel cover plate; 9: motor; 10: box body cover; 11: primary gear; 12: sealing plate; 13: gear shaft; 14: driving wheel.

### DETAILED DESCRIPTION

In order to make the objectives, technical solutions and advantages of the embodiments of the present invention clearer, a clear and complete description of the technical solutions in the embodiments of the present invention will be made hereinafter in combination with the drawings in the embodiments of the present invention. It is apparent that the described embodiments are not all but a part of the embodiments of the present invention. Based on the embodiments of the present invention, all other embodiments obtained by those of ordinary skills in the art without creative work are within the scope of the present invention.

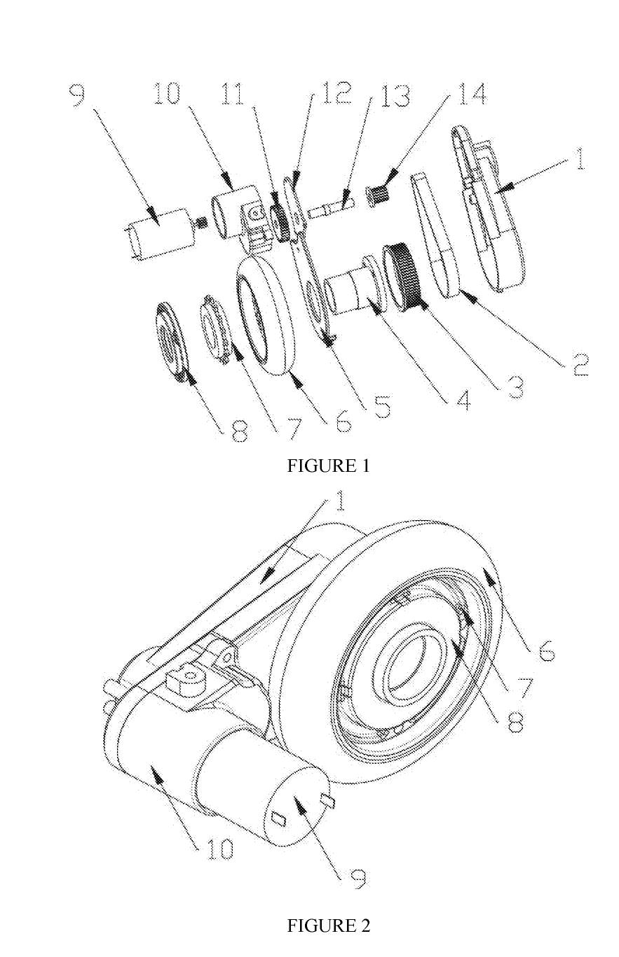

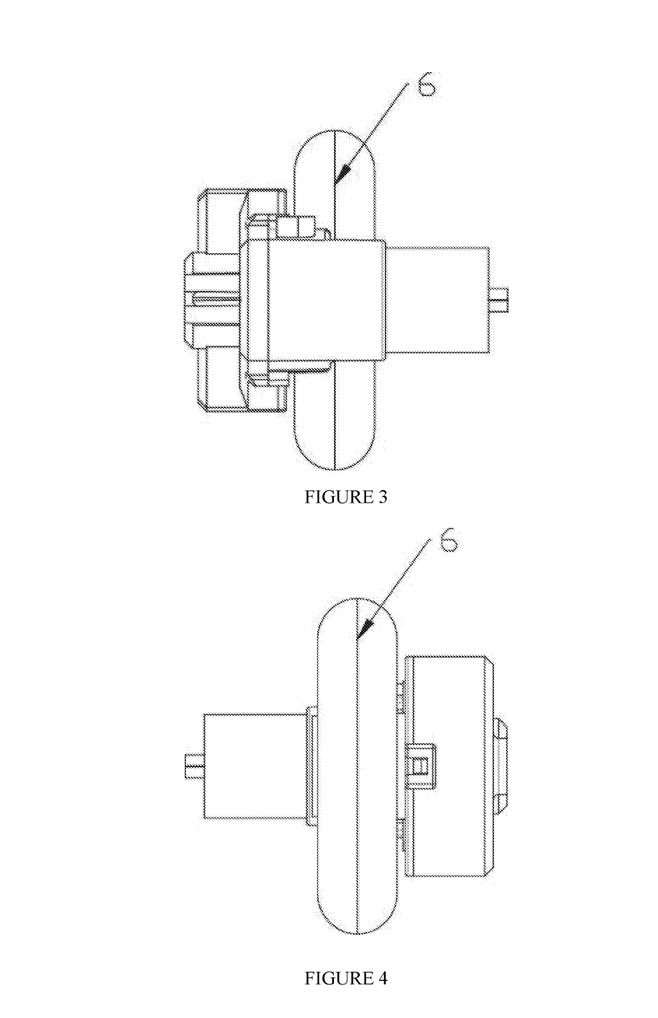

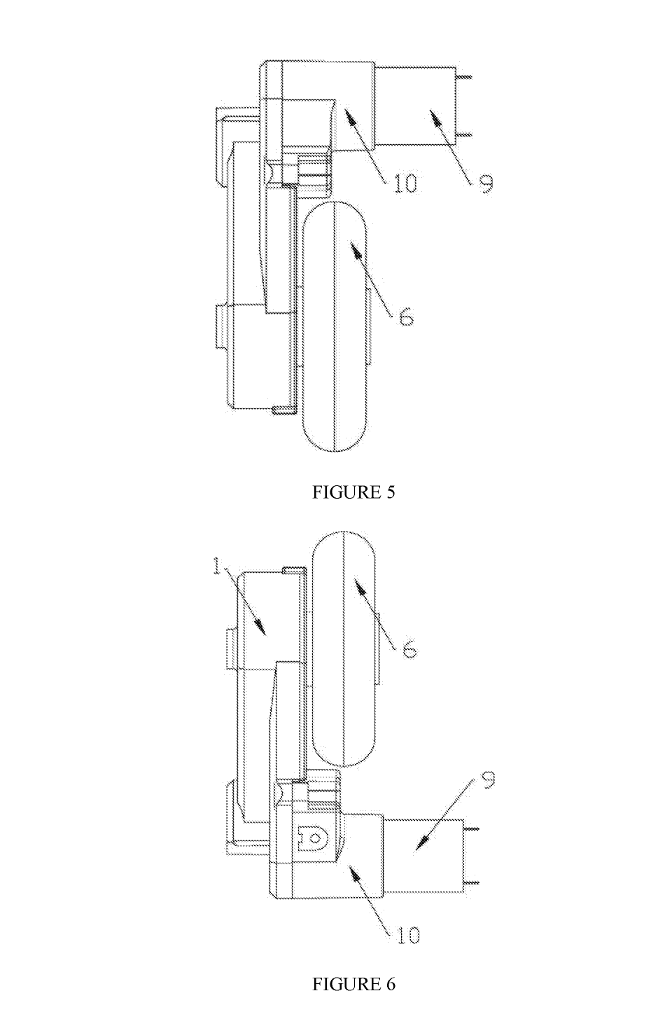

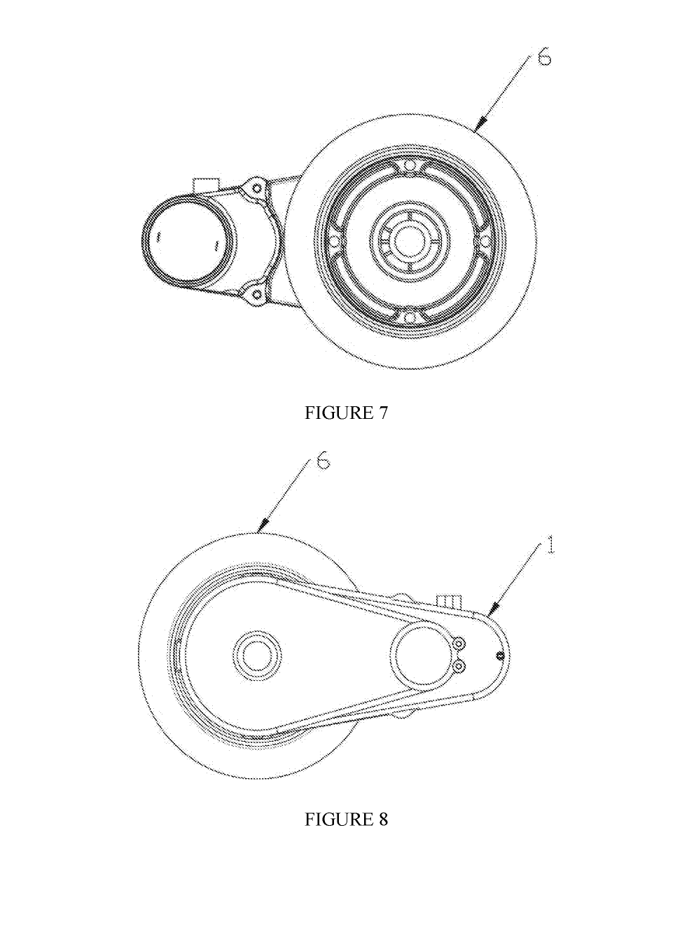

As illustrated in FIGS. 1 to 8, the embodiment of the present invention provides a transmission, an input end of the transmission being connected with a driving device, the driving device providing a power source for the transmission, an output end being connected with a rear wheel 6 for driving the rear wheel 6 to rotate, such that the vehicle moves forward; the transmission specifically comprising a gear transmission mechanism and a pulley transmission mechanism, the gear transmission mechanism comprising a primary gear 11 connected to the driving mechanism, the driving mechanism driving the primary gear 11 to rotate; the pulley transmission mechanism comprising a driving wheel 14, a driven wheel 3 and a synchronous belt 2; the driving wheel 14 being connected with the primary gear 11 through a gear shaft 13, a unidirectional transmission mechanism 7 connected to the driven wheel 3 being provided in the rear wheel 6, the unidirectional transmission mechanism 7 being used for driving the rear wheel 6 to rotate. In the present embodiment, the transmission provided by the present application comprises a two-stage gearshift, wherein the power provided by the driving device is transmitted to the pulley transmission mechanism through the gear transmission mechanism, the pulley transmission mechanism transmits the power to the unidirectional transmission mechanism 7, the unidirectional transmission mechanism 7 further drives the rear wheel 6 to rotate. The transmission is with simple structure, occupies small space, and is light in weight. It efficiently solves the problem of complex and cumbersome internal structure of the existing transmission. Wherein, the driving wheel 14 is a secondary front pulley of the synchronous belt 2, and the driven wheel 3 is a secondary rear pulley of the synchronous belt 2.

Specifically, when operating, the transmission provided by the present application provides power output by the driving device, transmits the power to the pulley transmission mechanism by the gear transmission mechanism, and the pulley transmission mechanism drives the rear wheel 6 to rotate through the unidirectional transmission mechanism 7, such that the vehicle moves forward; when the power output is stopped, due to the inertia effect of the vehicle and the relatively small rotation resistance of the unidirectional transmission mechanism 7, the vehicle can smoothly coast, while the driving mechanism, gear transmission mechanism and pulley transmission mechanism are not rotating, thereby achieving the advantageous effects of saving power consumption and improving endurance mileage.

Specifically, the unidirectional transmission mechanism 7 is connected with the driven wheel 3 by a thread bushing 4. In the present embodiment, the inner sides of the unidirectional transmission mechanism 7 and the driven wheel 3 are both provided with inner threads matching the thread bushing 4. This coupling method is of good transmission effect, and is simple in process, being capable of improving the installation efficiency of the transmission and is also easy for maintenance and overhaul.

Preferably, a first gear is provided in the rear wheel 6, and the periphery of the unidirectional transmission mechanism 7 is provided with a second gear engaged with the first gear, so as to complete the power transmission from the unidirectional transmission mechanism 7 to the rear wheel 6. It is of reliable operation and wide rotation speed range by employing the method of gear engaging, which is conducive to ensuring the normal operation of the transmission. Meanwhile, it is of light weight and small size, is simple in manufacturing process and low in production costs. It is helpful for improving economy, suitable for electric scooters with small costs.

Preferably, the unidirectional transmission mechanism 7 is a unidirectional flywheel or unidirectional bearing. A ratchet is provided in the unidirectional flywheel, through the ratchet a unidirectional rotation transmission is achieved; the unidirectional bearing is a bearing that can freely rotate in one direction and locked in the other direction. It is of small resistance by providing the unidirectional flywheel or the unidirectional bearing, so that the vehicle can smoothly coast; particularly for a small electric scooter, it can be ridden or driven in the form of one foot thrusting against the ground as a non-powered scooter, when the vehicle battery runs out of power.

Further, in order to avoid exposing the unidirectional transmission mechanism 7 and to improve aesthetics, the rear wheel 6 is further provided with a wheel cover plate 8 at the side away from the driven wheel 3, and the wheel cover plate 8 is fixed to the rear wheel 6 through screws. Particularly, in addition to the fixing method by using screws, the wheel cover plate 8 and the rear wheel 6 can also use other fixing connection methods such as engaging, embedding or clamping.

Further, in order to prevent ash from going into the transmission mechanism transmission affecting the usage, and concerning the aesthetics, the transmission further comprises a box body 1 provided with an opening, one side of the opening being provided with a box body cover 10, the other side of the opening being provided with a cover plate 5, the box body cover 10, cover plate 5 and box body 1 constituting a closed housing, both of the gear transmission mechanism and the pulley transmission mechanism being provided in the housing. Wherein, the cover plate 5 is provided at the connection of the rear wheel 6 and the box body 1.

Further, a sealing plate 12 is provided at the connection of the box body cover 10 and the box body 1, and the sealing plate 12 is disposed over the gear shaft 13. In the present embodiment, the contour shape of the sealing plate 12 matches the contour shape of the opening of the box body 1. It avoids the overflow of the lubricating oil on the primary gear 11, which affects the normal use of the transmission, by providing the sealing plate 12.

Preferably, the driving device is a motor 9, an output shaft of the motor 9 is connected with the primary gear 11. The output shaft is used for driving the primary gear 11 to rotate. In the present embodiment, the motor 9 is a 12 V high-rotation-speed micro-motor 9. Different from the conventional 6812-type motor 9, it is of lighter weight, lower cost and better economy. Particularly, in addition to the motor 9, the driving device can also be other power sources such as battery, solar or hydraulic or other power sources.

The present invention also provides an electric vehicle comprising the transmission above. It consumes low power, is capable of efficiently improving the endurance mileage of the electric vehicle, significantly enhancing the demands for transportation of the consumers, by using the transmission with the structure above. It should be noted that due to the light weight and small size, the transmission provided by the present application can also be widely used in the field of electric scooter, it is particularly suitable for electric scooters with two wheels, three wheels and four wheels. In addition to the descriptions above, the transmission above can also be suitable for ordinary vehicles, achieving the advantageous effect of reducing power consumption.

In summary, the present invention provides a transmission, with an input end connected with a driving device, an output end connected with a rear wheel, comprising a gear transmission mechanism and a pulley transmission mechanism, the gear transmission mechanism comprising a primary gear connected to the driving mechanism; the pulley transmission mechanism comprising a driving wheel, a driven wheel and a synchronous belt; the driving wheel being connected with the primary gear through a gear shaft, a unidirectional transmission mechanism connected to the driven wheel being provided in the rear wheel, the unidirectional transmission mechanism being used for driving the rear wheel to rotate. The transmission provided by the present application is with simple structure, small footprint and light weight; and provides power output by the driving device, transmits power to the pulley transmission mechanism by the gear transmission mechanism. The pulley transmission mechanism drives the rear wheel to rotate through the unidirectional transmission mechanism, such that the vehicle moves forward; when the power output is stopped, due to the inertia effect of the vehicle and the small rotation resistance of the unidirectional transmission mechanism, the vehicle can smoothly coast while the driving mechanism, gear transmission mechanism and pulley transmission mechanism are not rotating, thereby achieving the advantageous effects of saving power consumption and improving endurance mileage. The transmission is of strong practicability, is beneficial to the standardized production and promotion.

It should be noted that the embodiments above are only used to illustrate the technical solutions of the present invention, and are not intended to be limiting thereto; although the present invention has been described in detail with reference to the foregoing embodiments, it should be understood by those of ordinary skills in the art that the technical solutions described in the foregoing embodiments may be modified, or equivalently replaced with some of the technical features; while these modifications or substitutions do not make the essence of the corresponding technical solutions to depart from the spirit and scope of the technical solutions of each embodiment of the present invention.

1. A transmission, comprising:
an input end connected a driving device;
an output end connected to a rear wheel;
a gear transmission mechanism and a pulley transmission mechanism, the gear transmission mechanism comprising a primary gear connected to the driving device;
the pulley transmission mechanism comprising a driving wheel, a driven wheel and a synchronous belt;
the driving wheel being connected with the primary gear by a gear shaft; and
a unidirectional transmission mechanism connected to the driven wheel provided in the rear wheel, the unidirectional transmission mechanism driving the rear wheel to rotate.

2. The transmission of claim 1, wherein the unidirectional transmission mechanism is connected with the driven wheel with a thread bushing.

3. The transmission of claim 2, wherein the rear wheel further comprises a first gear, and a periphery of the unidirectional transmission mechanism further comprises a second gear engaged with the first gear.

4. The transmission of claim 1, wherein the unidirectional transmission mechanism is a unidirectional flywheel or a unidirectional bearing.

5. The transmission of claim 1, wherein the rear wheel further comprises a wheel cover plate at a side away from the driven wheel, and wherein the wheel cover plate is fixed to the rear wheel with fasteners.

6. The transmission of claim 2, further comprising a box having an opening, one side of the opening having a box body cover, another side of the opening having a cover plate, the box body cover, cover plate and box comprising a closed housing, wherein the gear transmission mechanism and the pulley transmission mechanism are in the housing.

7. The transmission of claim 6, further comprising a sealing plate at a connection of the box body cover and the box body, and wherein the sealing plate is disposed over the gear shaft.

8. The transmission of claim 1, wherein the driving device comprises a motor, wherein an output shaft of the motor is connected to the primary gear, and the output shaft drives the primary gear to rotate.

9. An electric motor, comprising:
a transmission, the transmission comprising:
an input end connected to a driving device;
an output end connected to a rear wheel;
a gear transmission mechanism and a pulley transmission mechanism, the gear transmission mechanism comprising a primary gear connected to the driving device;
the pulley transmission mechanism comprising a driving wheel, a driven wheel and a synchronous belt;
the driving wheel being connected with the primary gear by a gear shaft; and
a unidirectional transmission mechanism connected to the driven wheel provided in the rear wheel, the unidirectional transmission mechanism driving the rear wheel to rotate.

10. The electric motor of claim 9, wherein the unidirectional transmission mechanism is connected with the driven wheel with a thread bushing.

11. The electric motor of claim 10, wherein the rear wheel further comprises a first gear, and a periphery of the unidirectional transmission mechanism further comprises a second gear engaged with the first gear.

12. The electric motor of claim 9, wherein the unidirectional transmission mechanism is a unidirectional flywheel or a unidirectional bearing.

13. The electric motor of claim 9, wherein the rear wheel further comprises a wheel cover plate at a side away from the driven wheel, and wherein the wheel cover plate is fixed to the rear wheel with fasteners.

14. The electric motor of claim 13, further comprising a box having an opening, one side of the opening having a box body cover, another side of the opening having a cover plate, the box body cover, cover plate and box comprising a closed housing, wherein the gear transmission mechanism and the pulley transmission mechanism are in the housing.

15. The electric motor of claim 14, further comprising a sealing plate at a connection of the box body cover and the box body, and wherein the sealing plate is disposed over the gear shaft.

16. The electric motor of claim 9, wherein the driving device comprises a motor, wherein an output shaft of the motor is connected to the primary gear, and the output shaft drives the primary gear to rotate.
